(19) United States
(12) Patent Application Publication
(10) Pub. No.: US 2025/0218281 A1
(43) Pub. Date: Jul. 3, 2025

(54) INTERACTIVE APPARATUS AND CONTROL METHOD THEREOF

(71) Applicants: HON HAI PRECISION INDUSTRY CO., LTD., New Taipei City (TW); Foxconn Technology Group Co., Ltd., Guangdong Province (CN)

(72) Inventors: Tzu-Hsiang LAN, New Taipei City (TW); Jing-Kai HUANG, New Taipei City (TW)

(21) Appl. No.: 19/002,733

(22) Filed: Dec. 27, 2024

(30) Foreign Application Priority Data
Dec. 29, 2023 (TW) 112151667

(51) Int. Cl. G08C 17/02; G06F 3/01; G06T 7/73; G06V 10/40; G06V 10/764; G06V 10/77; G06V 10/94; G06V 40/18

(52) U.S. Cl. CPC G08C 17/02; G06F 3/013; G06T 7/74; G06V 10/40; G06V 10/764; G06V 10/7715; G06V 10/95; G06V 40/193; G06T 2207/30201; G08C 2201/34

(57) ABSTRACT

An interactive apparatus includes a first image capture apparatus, a second image capture apparatus, a communication interface, and a processor. The first image capture apparatus is configured to capture a face image of a user. The second image capture apparatus is configured to capture a scene image in a scene. The processor is configured to determine whether the user is in a gaze status based on the face image. In response to the user being in the gaze status, the processor is configured to identify a scene object in the scene image by using a recognition model. In response to the processor identifying the scene object in the scene image, the communication interface is configured to transmit a control request to the scene object to control the scene object.

### CROSS-REFERENCE TO RELATED APPLICATION

This application claims priority to Taiwan Application Serial Number 112151667, filed Dec. 29, 2023, which is herein incorporated by reference in its entirety.

### BACKGROUND

### Field of Invention

The present disclosure relates to an interactive apparatus and method. More particularly, the present disclosure relates to an interactive apparatus and method for controlling other apparatuses remotely.

### Description of Related Art

The current interactive apparatuses for virtual reality, augmented reality, or mixed reality are mostly used to allow users to interact with virtual objects, but there is a lack of applications for the interactive apparatuses (e.g., augmented reality glasses) interacting with physical objects in the real world.

In view of this, how to provide an interactive technology for users to interact with physical objects by using an interactive apparatus is the goal that the industry strives to work on.

### SUMMARY

The disclosure provides an interactive apparatus comprising a first image capture apparatus, a second image capture apparatus, a communication interface, and a processor. The first image capture apparatus is configured to capture a face image of a user. The second image capture apparatus is configured to capture a scene image in a scene. The processor is electrically connected to the first image capture apparatus, the second image capture apparatus, and the communication interface. The interactive apparatus is configured to execute the following operations. The processor determines whether the user is in a gaze status based on the face image. In response to the user being in the gazing status, the processor identifies at least one scene object in the scene image by using a recognition model. In response to the processor identifying the at least one scene object in the scene image, the communication interface transmits a control request to the at least one scene object to control the at least one scene object.

The disclosure further provides an interactive apparatus control method being adapted for use in an electronic apparatus. The interactive apparatus control method comprises the following steps: the electronic apparatus capturing a face image of a user and a scene image in a scene; the electronic apparatus determining whether the user is in a gaze status based on the face image; in response to the user being in the gazing status, the electronic apparatus identifying at least one scene object in the scene image by using a recognition model; and in response to identifying the at least one scene object in the scene image, the electronic apparatus transmitting a control request to the at least one scene object to control the at least one scene object.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating an interactive apparatus 1 according to a first embodiment of the present disclosure.

FIG. 2 is a flow diagram illustrating the interactive apparatus registering a scene object according to some embodiments of the present disclosure.

FIG. 3 is a flow diagram illustrating the interactive apparatus controlling the scene object in the scene according to some embodiments of the present disclosure.

FIG. 4 is a schematic diagram illustrating a recognition model according to some embodiments of the present disclosure.

FIG. 5 is a schematic diagram illustrating the interactive apparatus calculating a projection point corresponding to the sights of a user according to some embodiments of the present disclosure.

FIG. 6 is a schematic diagram illustrating the interactive apparatus calculating projection points corresponding to the scene objects according to some embodiments of the present disclosure.

FIG. 7 is a flow diagram illustrating the interactive apparatus controlling the scene object in the scene according to another embodiment of the present disclosure.

FIG. 8 is a schematic diagram illustrating a user interface and a menu according to some embodiments of the present disclosure.

FIG. 9 is a flow diagram illustrating an interactive apparatus control method according to a second embodiment of the present disclosure.

FIG. 10 is a flow diagram illustrating a part of the interactive apparatus control method according to some embodiments of the present disclosure.

FIG. 11 is a flow diagram illustrating another part of the interactive apparatus control method according to some embodiments of the present disclosure.

FIG. 12-15 are flow diagrams illustrating details of some steps in the interactive apparatus control method according to some embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

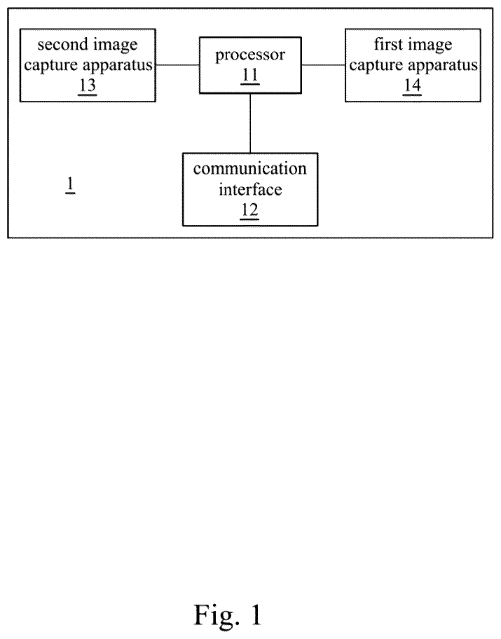

Please refer to FIG. 1, which is a schematic diagram illustrating an interactive apparatus 1 according to a first embodiment of the present disclosure. The interactive apparatus 1 comprises a processor 11, a communication interface 12, a second image capture apparatus 13, and a first image capture apparatus 14, wherein the processor 11 is electrically connected to the communication interface 12, the second image capture apparatus 13, and the first image capture apparatus 14 respectively. The interactive apparatus 1 is configured to let the user to interact with a scene object in physical environment. For example, in the application field of smart home appliances, the user may operate the interactive apparatus 1 to connect and control the appliance nearby (e.g., stereo, lamp, air conditioner); in the application field of smart manufacturing, the user may operate the interactive apparatus 1 to connect and control the instrument in the factory (e.g., exhaust fan, machine tool). In some embodiments, the interactive apparatus 1 may be virtual reality glasses, augmented reality glasses, or mixed reality glasses.

The processor 11 is configured to execute computation. In some embodiments, the processor 11 comprises a central processing unit (CPU), a graphics processing unit (GPU), a multi-processor, a distributed processing system, an application specific integrated circuit (ASIC), and/or a suitable processing unit.

The communication interface 12 is configured to transmit and/or receive data from other apparatus. In some embodiments, the communication interface 12 comprises Bluetooth interface, Wi-Fi interface, and/or other data transceiver interface.

The second image capture apparatus 13 is configured to capture a scene image in the scene the interactive apparatus 1 situated. In some embodiments, the second image capture apparatus 13 may comprise one or more camera configured on the glasses and configured to shoot towards the outside of the glasses (i.e., not towards the user side).

The first image capture apparatus 14 is configured to capture a face image of the user. In some embodiments, the first image capture apparatus 14 may comprise one or more camera configured on the glasses and configured to shoot towards the user.

In some embodiments, the interactive apparatus 1 also comprises a storage, the storage is electrically connected to the processor 11. Furthermore, before connecting and controlling a scene object, the interactive apparatus 1 may exchange certificate with the scene object first to register information of each other. Accordingly, the interactive apparatus 1 and the scene object may verify the permission with each other while connected.

Specifically, the interactive apparatus 1 may register the scene object through the following operations: the processor 11 obtaining at least one identification data corresponding to the at least one scene object; the communication interface 12 receiving at least one certificate corresponding to the at least one scene object from a server, wherein the at least one certificate is generated by the server in response to receiving the at least one identification data from the interactive apparatus; and the storage storing the at least one certificate; wherein the control request transmitted by the communication interface further comprises the at least one certificate corresponding to the at least one scene object.

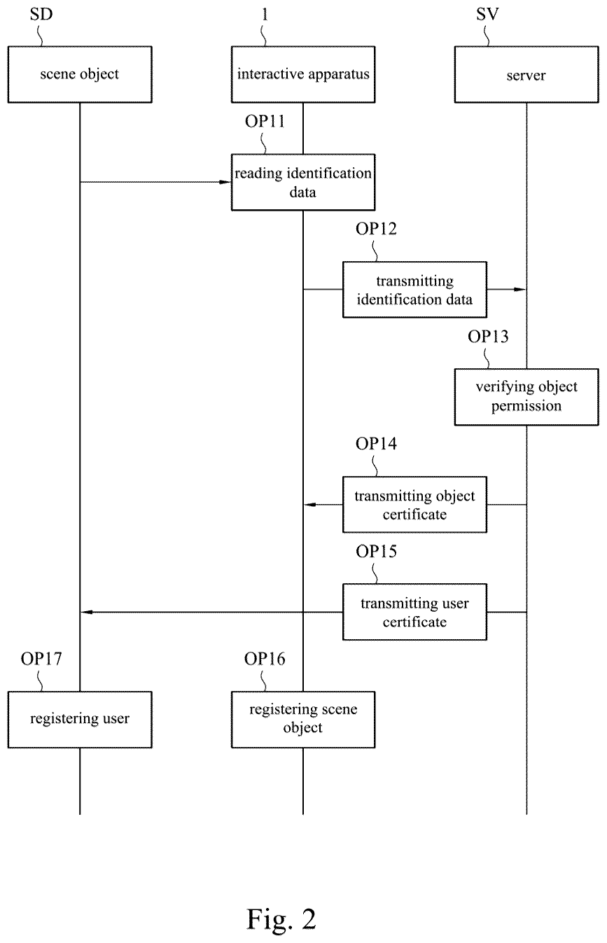

Related to the operation of the interactive apparatus 1 registering the scene object, please refer to FIG. 2, which is a flow diagram illustrating the interactive apparatus 1 registering a scene object according to some embodiments of the present disclosure.

First, the interactive apparatus 1 executes an operation OP11, reading identification data from a scene object SD. Specifically, the interactive apparatus 1 may obtain the identification data through scanning 2D barcode, downloading from gateway, or other operation, wherein the identification data may be a unique character string or in other data format for identification.

Next, the interactive apparatus 1 executes an operation OP12, transmitting the identification data to a server SV. Correspondingly, after receiving the identification data, the server SV executes an operation OP13, verifying object permission based on the identification data.

Specifically, the server SV may identify the scene object SD and confirm the status of the scene object SD based on the identification data. For example, if the scene object SD has not been registered by other interactive apparatus, the server SV is able to confirm that the interactive apparatus 1 is the owner of the scene object SD and has the control permission of the scene object SD. On the other hand, if the scene object SD has been registered by other interactive apparatus in the past, the server SV then may notify the owner of the scene object SD (i.e., the first interactive apparatus registering the scene object SD) and check with the owner for permission of controlling the scene object SD with the interactive apparatus 1.

After confirming that the interactive apparatus 1 has the control permission of the scene object SD, the server SV executes operations OP14 and OP15, transmitting an object certificate to the interactive apparatus 1 and transmitting a user certificate to the scene object SD, wherein the object certificate is the permission certificate of the scene object SD, and the user certificate is the permission certificate of the interactive apparatus 1. Correspondingly, the interactive apparatus 1 executes an operation OP16 after receiving the object certificate, storing the object certificate into the storage to register the scene object SD; and the scene object SD executes an operation OP17 after receiving the user certificate, storing the user certificate to register the interactive apparatus 1. It is noticed that, the execution order of the operations OP14 and OP15 is not limited in the present disclosure.

Accordingly, the interactive apparatus 1 and the scene object SD are able to exchange the object certificate and the user certificate and validate the received certificates to confirm the identification and the control permission of the connected object while connecting to each other in the future.

In some embodiments, the storage of the interactive apparatus 1 comprises a semiconductor or solid-state memory, a magnetic tape, a removable computer diskette, a random-access memory (RAM), a read-only memory (ROM), a rigid magnetic disk, and/or an optical disk.

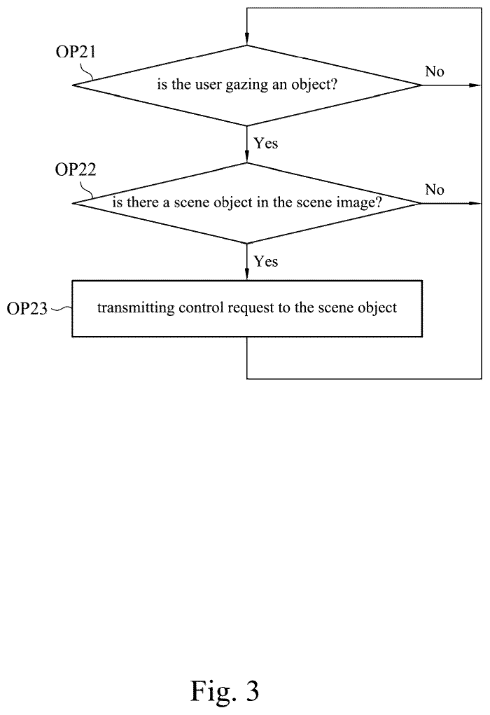

About the operation of the interactive apparatus 1 interacting with the scene object in the scene, please refer to FIG. 3, the interactive apparatus 1 is configured to execute operations OP21-OP23 to control the scene object in the scene.

First, the interactive apparatus 1 executes the operation OP21, the processor 11 determines whether the user is gazing at an object. Specifically, the processor 11 determines whether a user is in a gaze status based on a face image captured by the first image capture apparatus 14.

In some embodiments, the processor 11 calculates a plurality of pupil sizes and a plurality of sight angles based on a plurality of eye images in the face image; and the processor 11 determines whether the user is in the gaze status based on the pupil sizes and the sight angles.

For example, when the user intents to control a scene object, the expression of the user will take specific characteristics due to gazing at the scene object. For example, concentrated vision, constricted pupils, frowning, etc. due to focusing on specific objects. Correspondingly, the processor 11 may determine whether the user is gazing at a specific object by changes in pupil size, sight angle, and/or facial expression characteristics in the face image.

Furthermore, if the processor 11 determines that the user is not in the gaze status, the interactive apparatus 1 continues to execute the operation OP21 and not execute the following operation. Namely, the interactive apparatus 1 will continuously determines whether the user is in the gaze status until the determination result is positive and then executing the operation OP22.

On the other hand, if the processor 11 determines that the user is in the gaze status, the interactive apparatus 1 executes the operation OP22, the processor 11 determines whether there is a scene object in the scene image. Specifically, the processor 11 identifies at least one scene object in the scene image captured by the second image capture apparatus 13 by using a recognition model.

For example, the processor 11 inputs the scene image into the recognition model to determine whether the scene image comprises controllable apparatuses (e.g., appliances, IoT apparatuses).

It is noted that, the recognition model may be a trained machine learning model for image recognition. In some embodiments, the images of the apparatuses the interactive apparatus 1 may interacted with can be taken as the training data, and an image recognition machine learning model is taken as the recognition model after trained by the training data.

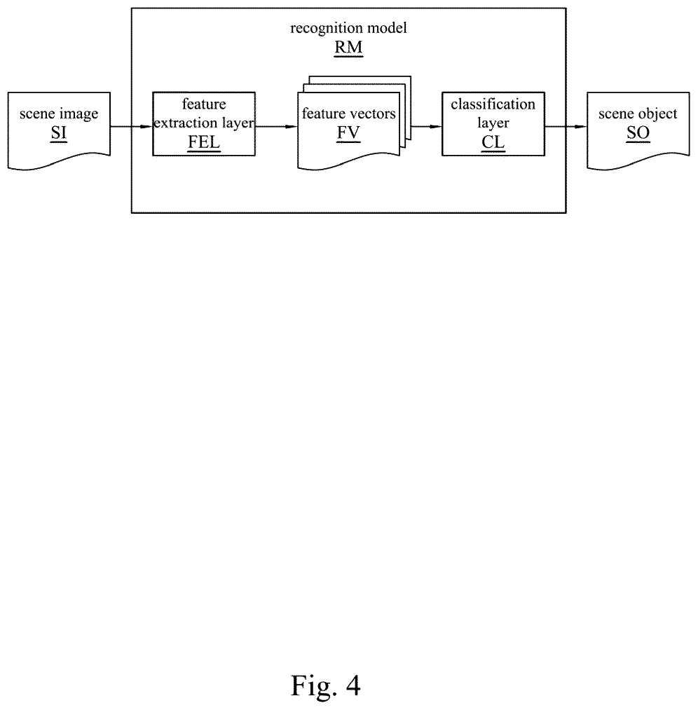

In some embodiments, please refer to FIG. 4, a recognition model RM comprises a feature extraction layer FEL and a classification layer CL, the feature extraction layer FEL is configured to output multiple feature vectors FV based on a scene image SI, and the classification layer CL is configured to identify at least one scene object SO in the scene image SI based on the feature vectors FV outputted by the feature extraction layer FEL.

In this embodiment, the recognition model RM comprises the feature extraction layer FEL with fewer parameters and the classification layer CL with more parameters. Accordingly, when the recognition model RM needs to be updated, different update approaches can be adopted for different functions of the feature extraction layer FEL and the classification layer CL respectively.

In some embodiments, since the feature extraction layer FEL comprises fewer parameters, and the computational complexity of training is lower, the processor 11 may further train the feature extraction layer FEL based on at least one object image corresponding to the at least one scene object SO in the scene image SI. Since the same scene object may have different appearances due to customize decoration by the user (e.g., changing color, adding pattern), the interactive apparatus 1 trains the feature extraction layer FEL by using the captured image of the scene object SO to improve the accuracy of image recognition in the future.

In some embodiments, the communication interface 12 of the interactive apparatus 1 also receives at least one preset image corresponding to the scene object SO from a server; and the processor 11 training the feature extraction layer FEL based on the at least one preset image. Accordingly, the interactive apparatus 1 is able to train the feature extraction layer FEL by using the preset image downloaded from the server, so as to improve the recognition accuracy on the scene object, wherein the preset image may comprise images of the existing scene object and also images of other scene objects.

In some embodiments, the communication interface 12 of the interactive apparatus 1 also receives an update parameter from a server; and the processor 11 updates the recognition model based on the update parameter. As mentioned above, the recognition model RM may comprise the classification layer CL with more parameters, and the interactive apparatus 1 needs more time and higher power consumption for training the classification layer CL. Therefore, the recognition model RM can be trained by the server, and the server transmits the update parameters after training to the interactive apparatus 1 to update the recognition model RM stored in the interactive apparatus 1, wherein the update parameters are able to update the feature extraction layer FEL and/or the classification layer CL of the recognition model RM.

It is noted that, the aforementioned server may be a cloud server, and the interactive apparatus 1 may connect to the server via the communication interface 12 (e.g., data transceiver interface or other data transmission interface) to transmit data.

In some embodiments, when recognizing multiple scene objects SO in the scene image SI, the interactive apparatus 1 also determines the scene object which the user wants to control based on the gaze direction of the user.

Specifically, the at least one scene object comprises a first scene object and a second scene object, and the operation of the communication interface 12 transmitting the control request to the at least one scene object further comprises: the processor 11 calculating a left-eye sight and a right-eye sight based on the face image; based on an intersection of the left-eye sight and the right-eye sight, the processor 11 calculating a projection point of the intersection on a plane; the processor 11 selecting a selected scene object from the first scene object and the second scene object based on the projection point; and the communication interface 12 transmitting the control request to the selected scene object to control the selected scene object.

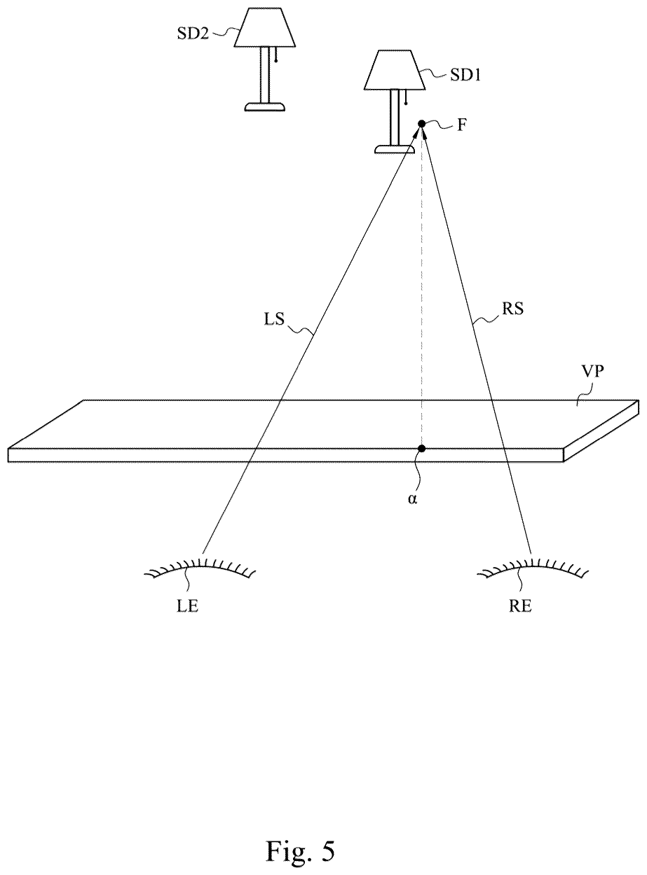

Please refer to FIG. 5, which is a schematic diagram illustrating the interactive apparatus 1 calculating a projection point a corresponding to the sights of a user according to some embodiments of the present disclosure. As shown in FIG. 5, the processor 11 may calculate a sight LS of a left eye LE and a sight RS of a right eye RE of the user. Furthermore, the processor 11 calculates an intersection point F of the sights LS and RS and projects the intersection point F on the projection point a at a virtual plane VP generated by the processor 11, wherein the virtual plane VP may be a plane perpendicular to the direction the user facing and/or a plane parallel to the scene image.

Accordingly, after calculating the projection point, the interactive apparatus 1 is able to calculate the distances between the projection point and multiple scene objects respectively and further transmit the control request to the nearest scene object.

Furthermore, in some embodiments, the interactive apparatus 1 also performs multi-antenna positioning on multiple scene objects respectively by using multiple antennas and determines the object that the user wants to control based on the positioning result.

Specifically, the communication interface 12 further comprises a first antenna and a second antenna, and the operation of the processor 11 selecting the selected scene object further comprises: the first antenna and the second antenna receiving a plurality of positioning signals from the first scene object and the second scene object respectively; the processor 11 calculating a first projection point and a second projection point of the first scene object and the second scene object on the plane respectively based on the positioning signals; and the processor 11 selecting the selected scene object based on the projection point, the first projection point, and the second projection point.

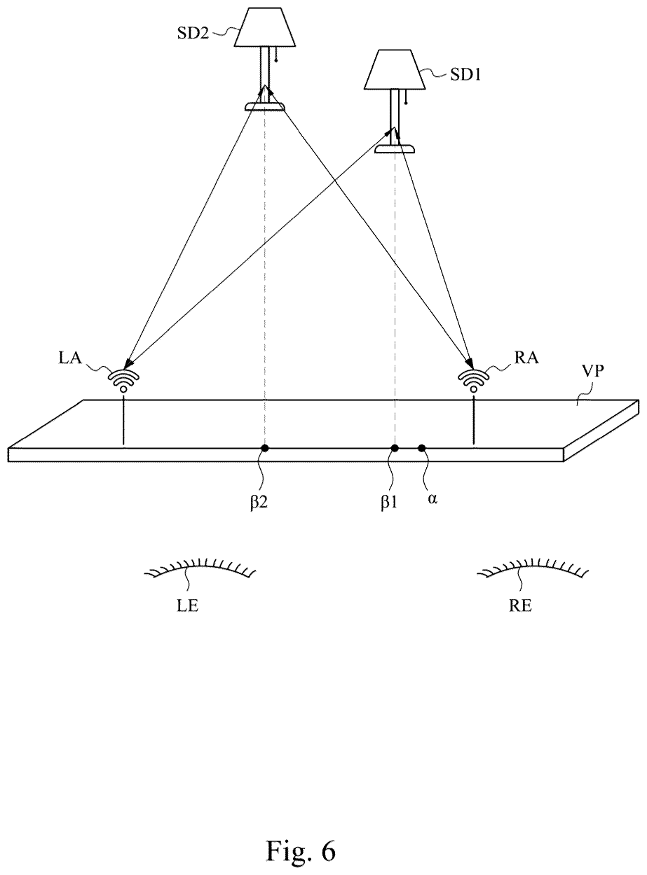

Please refer to FIG. 6, which is a schematic diagram illustrating the interactive apparatus 1 calculating projection points 31 and 2 corresponding to the scene objects according to some embodiments of the present disclosure. As shown in FIG. 6, the processor 11 of the interactive apparatus 1 comprises antennas LA and RA. The interactive apparatus 1 is able to position scene objects SD1 and SD2 in 3D space respectively through angle of departure (AoD) or other method. Also, the processor 11 calculates the projection point β1 corresponding to the scene object SD1 and the projection point β2 corresponding to the scene object SD2 on the virtual plane VP based on the positions of the scene objects SD1 and SD2. In some embodiments, the antennas LA and RA perform multi-antenna positioning by using Bluetooth, Wi-Fi, or other wireless protocol.

Furthermore, after obtaining the projection points β1 and β2, the interactive apparatus 1 selects the projection point closer to the projection point a among the projection points 31 and 32 and control the corresponding scene object.

In some embodiments, the interactive apparatus 1 also comprises an input interface. When the interactive apparatus 1 connects to the wrong scene object, the user may input command to the input interface by eye movement, gesture, speech, or other behavior to cancel the connection. The input interface may comprise camera, microphone, button, remote controller, joystick, and/or other input interface.

In some embodiments, when the interactive apparatus 1 recognizes a plurality of scene objects SO in the scene image SI and does not select one of the scene objects SO due to failure of determination, user cancellation of connection, or other reasons in the meantime, the interactive apparatus 1 may also provide a menu for the user to select and control the scene object.

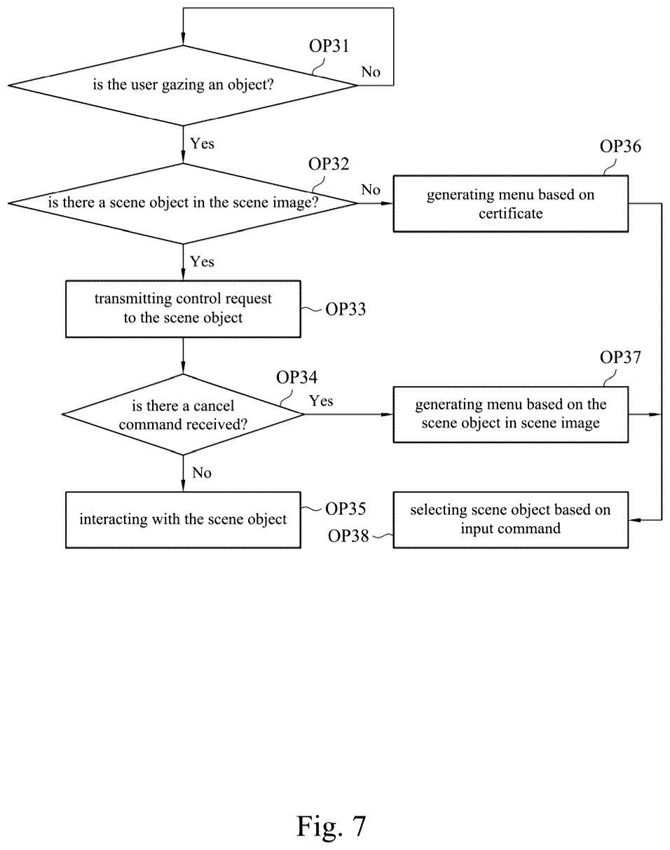

Please refer to FIG. 7, the interactive apparatus 1 may generate a menu for the user to select the correct scene object through operations OP31-OP38, wherein the operation OP31 is the same as the operation OP21 shown in FIG. 3, the operation OP32 is the same as the operation OP22 shown in FIG. 3, the operation OP33 is the same as the operation OP23 shown in FIG. 3, and the detail will not be repeated.

Different from the operations shown in FIG. 3, in the operation OP32, if the interactive apparatus 1 does not recognize scene objects in the scene image, the interactive apparatus 1 may execute the operation OP36, the processor 11 generates a menu based on the certificate stored in the storage, and the menu lists the scene objects registered previously for the user to select.

On the other hand, after executing the operation OP33, if the interactive apparatus 1 receives a cancel command inputted by the user from the input interface, the interactive apparatus 1 may execute the operation OP37, the processor 11 generates a menu based on the scene object recognized in the operation OP32, and the menu lists the scene objects in the scene image for the user to select. Relatively, if the input interface does not receive the cancel command, the interactive apparatus 1 may execute the operation OP35, continue to interact with the scene object.

After executing the operation OP36 and/or OP37, the interactive apparatus 1 may execute the operation OP38, the processor 11 selects the scene object based on input command received by the input interface, namely, selecting the object to interacting with according to the scene object selected by the user from the menu.

In some embodiments, if the menu provided by the interactive apparatus 1 while executing the operation OP37 is not able to fulfill the user's need, the interactive apparatus 1 may also return to the operation OP36, generating a menu based on the certificate to for the user to select.

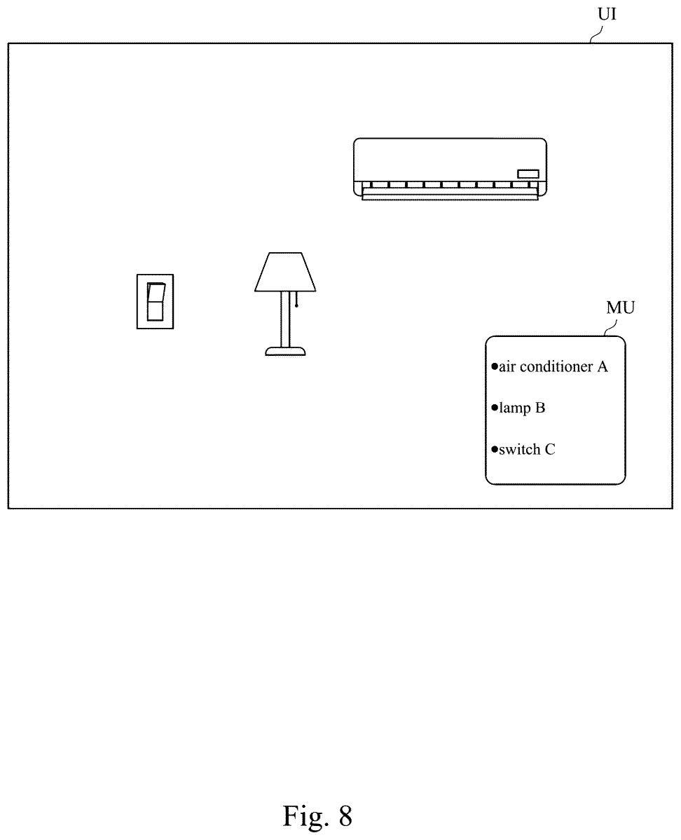

About the menu generated by the interactive apparatus 1 while executing the operation OP37, please refer to FIG. 8, which is a schematic diagram illustrating a user interface and a menu according to some embodiments of the present disclosure. As shown in FIG. 8, there are three scene objects in the scene presented in the user interface UI: an air conditioner A, a lamp B, and a switch C. After recognizing the three scene objects, the interactive apparatus 1 provides a menu MU listing the three scene objects in the user interface UI for the user to select the scene object to control.

Similarly, the menu generated by the interactive apparatus 1 while executing the operation OP36 may also be presented in a manner similar to the menu MU, and the difference lies in how the options in the menu are generated, thus the detail will not be repeated.

Finally, please return to FIG. 3, after confirming the scene object (e.g., selecting the scene object SD1), the interactive apparatus 1 executes the operation OP23, the communication interface 12 transmits a control request to the scene object SD1 to control the scene object SD1.

For example, the communication interface 12 may connect to the scene object SD1 via exchanging certificates or Secure Sockets Layer (SSL) between Internet of Things (IoT) apparatuses.

After establishing the connection, the user is able to control the scene object SD1 by using the interactive apparatus 1 to execute corresponding functions such as adjusting lamp brightness, turning on/off the lamp, etc. It is noted that, the functions executed by the scene object are determined by the type of the apparatus. For example, if the scene object is an exhaust fan, then the interactive apparatus 1 may control the operating power of the scene object; if the scene object is an air conditioner, then the interactive apparatus 1 may control the outlet temperature of the scene object, and the present disclosure is not limited to the aforementioned examples.

In some embodiments, the scene object SD1 confirms the control permission of the interactive apparatus 1 according to the object certificate transmitted from the communication interface 12, e.g., with all of the permissions or part of the permissions. Relatively, the interactive apparatus 1 also identifies the scene object SD1 according to the user certificate transmitted from the scene object SD1 in order to confirm whether it is connected to the correct scene object.

In summary, the interactive apparatus 1 provided by the present disclosure is able to determine whether the user wants to control a scene object based on the face image of the user and recognize the scene object in the environment by using a recognition model, so as to connect to and control the scene object. Additionally, the interactive apparatus 1 may also pre-register the certificate corresponding to a scene object, and then the interactive apparatus 1 is able to confirm whether it is connected to the correct scene object during connection. Furthermore, the interactive apparatus 1 determines sight directions of the user based on the eye image and further combines with the position of the scene object obtained through multi-antenna positioning, so as to connect to the scene object gazed by the user. When the recognition model is needed to be update, the interactive apparatus 1 may locally update the feature extraction layer in the recognition model by the captured object image or the downloaded preset image and download the update parameters directly to update the classification layer CL in the recognition model RM, so as to improve the efficiency of updating the recognition model.

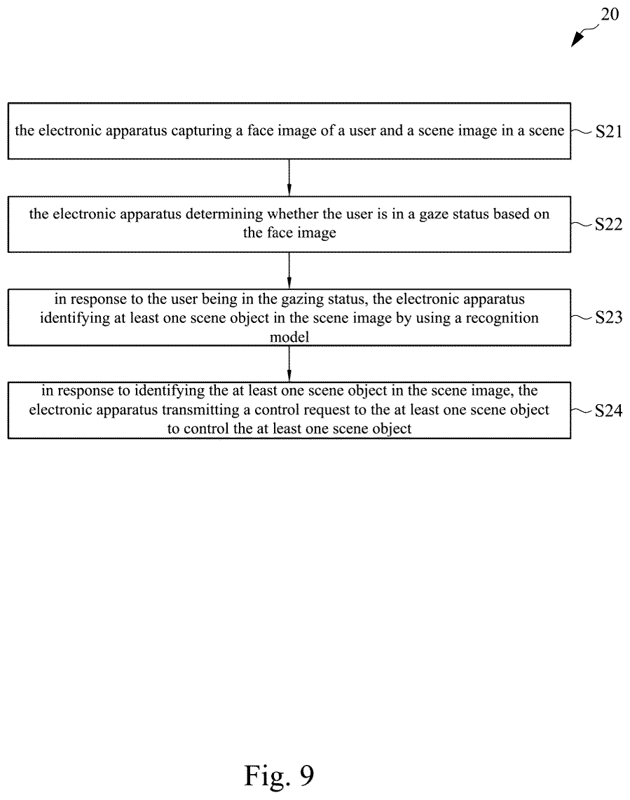

Please refer to FIG. 9, which is a flow diagram illustrating an interactive apparatus control method 20 according to a second embodiment of the present disclosure. The interactive apparatus control method 20 comprises steps S21-S23. The interactive apparatus control method 20 is configured to let the user interacting with the scene object in the environment. The interactive apparatus control method 20 can be executed by an electronic apparatus (e.g., the interactive apparatus 1 shown in FIG. 1).

In some embodiments, the electronic apparatus comprises a processor (e.g., the processor 11 shown in FIG. 1), a communication interface (e.g., the communication interface 12 shown in FIG. 1), a second image capture apparatus (e.g., the second image capture apparatus 13 shown in FIG. 1), and a first image capture apparatus (e.g., the first image capture apparatus 14 shown in FIG. 1), wherein the first image capture apparatus is configured to capture a face image of a user, the second image capture apparatus is configured to capture a scene image in a scene, and the processor is electrically connected to the first image capture apparatus, the second image capture apparatus, and the communication interface.

First, in the step S21, the electronic apparatus captures a face image of a user and a scene image in a scene.

Next, in the step S22, the electronic apparatus determines whether the user is in a gaze status based on the face image.

Next, in the step S23, in response to the user being in the gazing status, the electronic apparatus identifies at least one scene object in the scene image by using a recognition model.

Finally, in the step S24, in response to identifying the at least one scene object in the scene image, the electronic apparatus transmits a control request to the at least one scene object to control the at least one scene object.

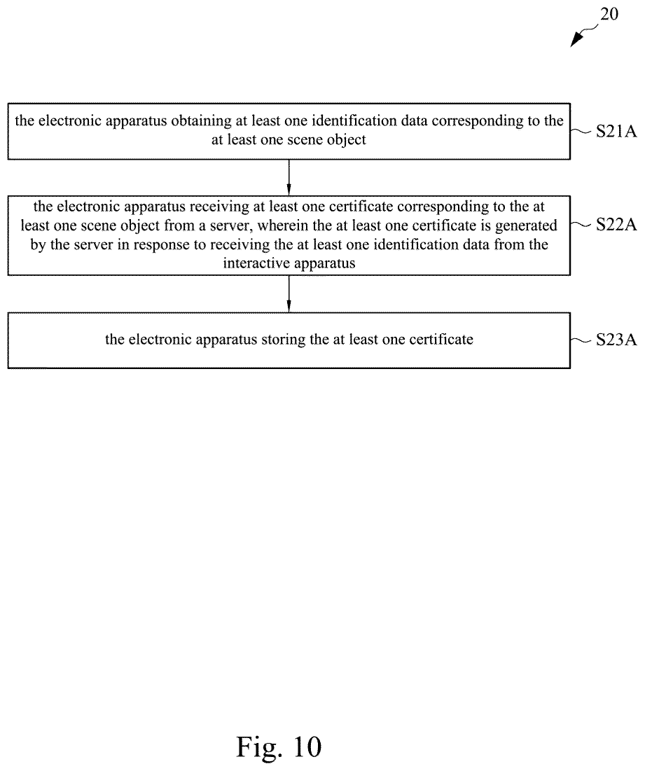

In some embodiments, the interactive apparatus control method 20 further comprises steps S21A-S23A shown in FIG. 10.

In the step S21A, the electronic apparatus obtains at least one identification data corresponding to the at least one scene object.

In the step S22A, the electronic apparatus receives at least one certificate corresponding to the at least one scene object from a server, wherein the at least one certificate is generated by the server in response to receiving the at least one identification data from the electronic apparatus.

In the step S23A, the electronic apparatus stores the at least one certificate.

Wherein the control request transmitted by the electronic apparatus further comprises the at least one certificate corresponding to the at least one scene object.

In some embodiments, the electronic apparatus further comprises a storage (e.g., the storage of the interactive apparatus 1 in the first embodiment), the storage is electrically connected to the processor and configured to store at least one certificate.

In some embodiments, the interactive apparatus control method 20 further comprises the electronic apparatus receiving a confirmation response from the at least one scene object to establish a connection, wherein the confirmation response is generated after the at least one scene object has validated the at least one certificate of the control request.

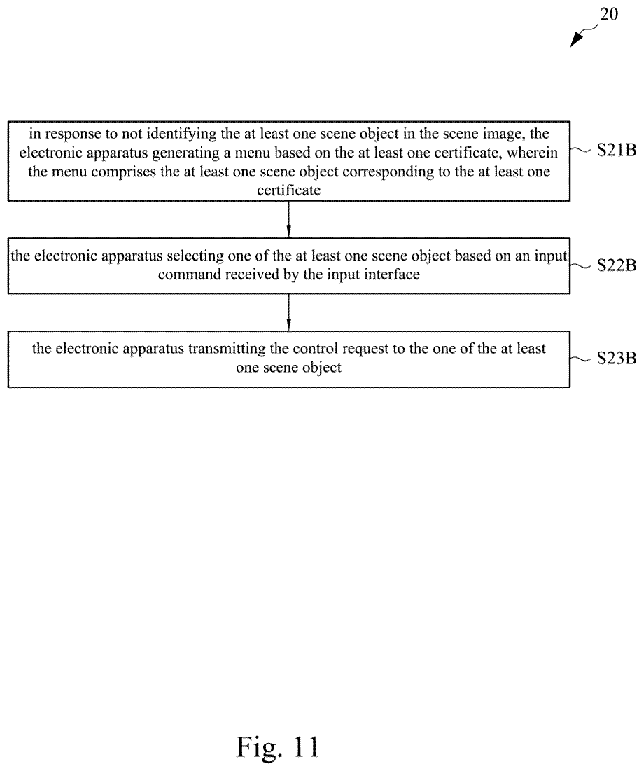

In some embodiments, the interactive apparatus control method 20 further comprises steps S21B-S23B shown in FIG. 11.

In the step S21B, in response to not identifying the at least one scene object in the scene image, the electronic apparatus generates a menu based on the at least one certificate, wherein the menu comprises the at least one scene object corresponding to the at least one certificate.

In the step S22B, the electronic apparatus selects one of the at least one scene object based on an input command received.

In the step S23B, the electronic apparatus transmits the control request to the one of the at least one scene object.

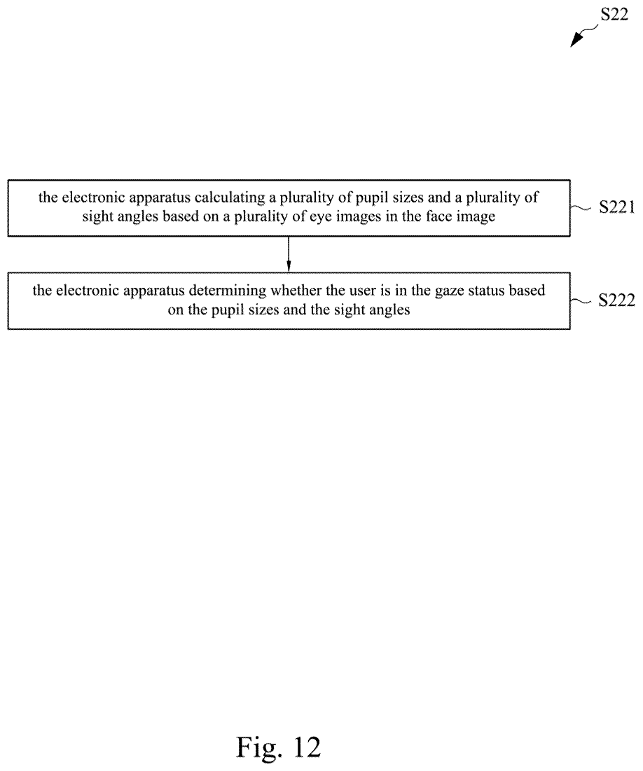

In some embodiments, the step S22 further comprises steps S221 and S222 shown in FIG. 12.

In the step S221, the electronic apparatus calculates a plurality of pupil sizes and a plurality of sight angles based on a plurality of eye images in the face image.

In the step S222, the electronic apparatus determines whether the user is in the gaze status based on the pupil sizes and the sight angles.

In some embodiments, the recognition model further comprises a feature extraction layer and a classification layer, the feature extraction layer is configured to output a plurality of feature vectors based on the scene image, and the classification layer is configured to identify the at least one scene object in the scene image based on the feature vectors outputted by the feature extraction layer.

In some embodiments, the recognition model further comprises a feature extraction layer, and the interactive apparatus control method 20 further comprises the electronic apparatus training the feature extraction layer based on at least one object image corresponding to the at least one scene object in the scene image.

In some embodiments, the recognition model further comprises a feature extraction layer, and the interactive apparatus control method 20 further comprises the electronic apparatus receiving at least one preset image corresponding to the at least one scene object from a server; and the electronic apparatus training the feature extraction layer based on the at least one preset image.

In some embodiments, the interactive apparatus control method 20 further comprises the electronic apparatus receiving an update parameter from a server; and the electronic apparatus updating the recognition model based on the update parameter.

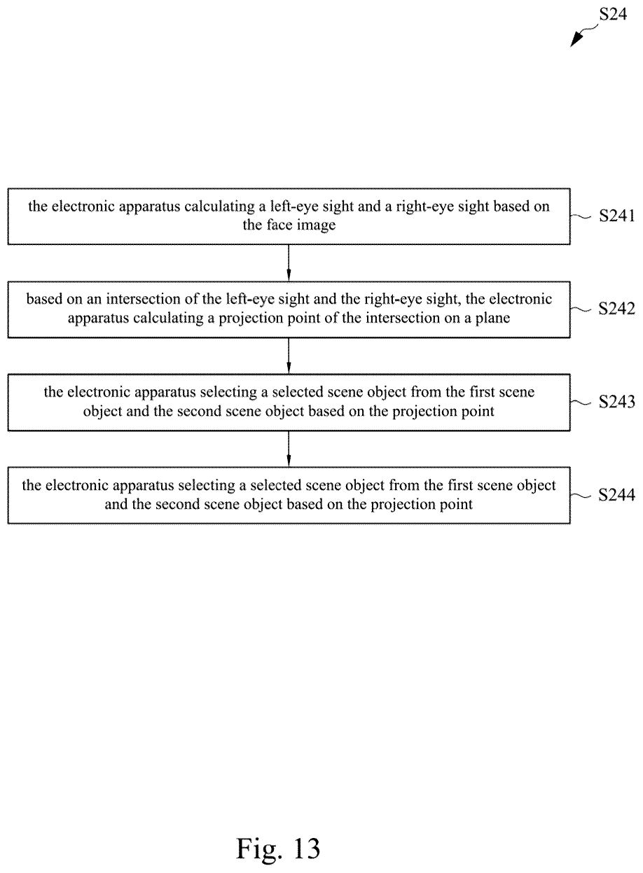

In some embodiments, the at least one scene object comprises a first scene object and a second scene object, and the step S24 further comprises steps S241-S244 shown in FIG. 13.

In the step S241, the electronic apparatus calculates a left-eye sight and a right-eye sight based on the face image.

In the step S242, based on an intersection of the left-eye sight and the right-eye sight, the electronic apparatus calculates a projection point of the intersection on a plane.

In the step S243, the electronic apparatus selects a selected scene object from the first scene object and the second scene object based on the projection point.

In the step S244, the electronic apparatus transmits the control request to the selected scene object to control the selected scene object.

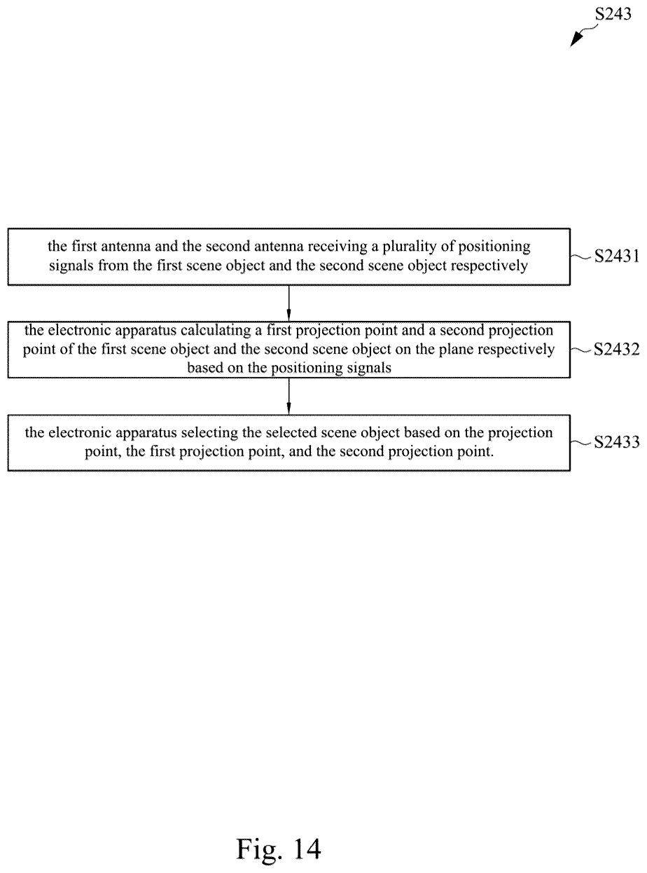

In some embodiments, the electronic apparatus further comprises a first antenna and a second antenna, and the step S243 further comprises steps S2431-S2433 shown in FIG. 14.

In the step S2431, the first antenna and the second antenna receives a plurality of positioning signals from the first scene object and the second scene object respectively.

In the step S2432, the electronic apparatus calculates a first projection point and a second projection point of the first scene object and the second scene object on the plane respectively based on the positioning signals.

In the step S2433, the electronic apparatus selects the selected scene object based on the projection point, the first projection point, and the second projection point.

In some embodiments, the interactive apparatus control method 20 further comprises in response to identifying the at least one scene object in the scene image, the electronic apparatus generating a menu based on the at least one scene object; and the electronic apparatus transmitting the control request to one of the at least one scene object based on an option selected by the user in the menu.

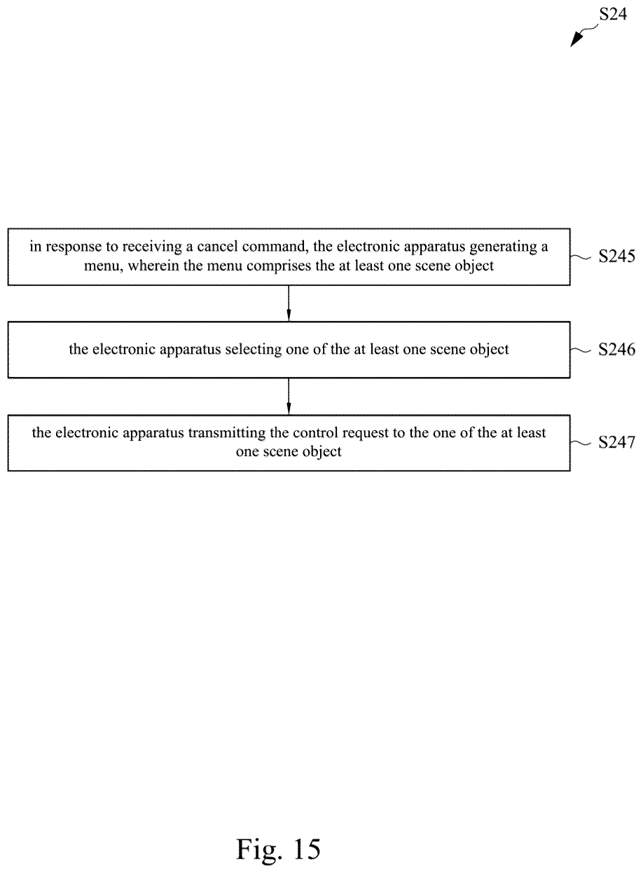

In some embodiments, the step S24 further comprises steps S245-S247 shown in FIG. 15.

In the step S245, in response to receives a cancel command, the electronic apparatus generating a menu, wherein the menu comprises the at least one scene object.

In the step S246, the electronic apparatus selects one of the at least one scene object based on an input command received.

In the step S247, the electronic apparatus transmits the control request to the selected one of the at least one scene object.

In some embodiments, the electronic apparatus further comprises an input interface, the input interface is configured to receive a command from the user, e.g., the cancel command and/or the input command.

In summary, the interactive apparatus control method 20 provided by the present disclosure is able to determine whether the user wants to control a scene object based on the face image of the user and recognize the scene object in the environment by using a recognition model, so as to connect to and control the scene object. Additionally, the interactive apparatus control method 20 may also pre-register the certificate corresponding to a scene object, and then the interactive apparatus control method 20 is able to confirm whether it is connected to the correct scene object during connection. Furthermore, the interactive apparatus control method 20 determines sight directions of the user based on the eye image and further combines with the position of the scene object obtained through multi-antenna positioning, so as to connect to the scene object gazed by the user. When the recognition model is needed to be update, the interactive apparatus control method 20 may locally update the feature extraction layer in the recognition model by the captured object image or the downloaded preset image and download the update parameters directly to update the classification layer CL in the recognition model RM, so as to improve the efficiency of updating the recognition model.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An interactive apparatus, comprising:
a first image capture apparatus, configured to capture a face image of a user;
a second image capture apparatus, configured to capture a scene image in a scene;
a communication interface; and
a processor, electrically connected to the first image capture apparatus, the second image capture apparatus, and the communication interface;
wherein the interactive apparatus is configured to execute the following operations:
the processor determining whether the user is in a gaze status based on the face image;
in response to the user being in the gazing status, the processor identifying at least one scene object in the scene image by using a recognition model; and
in response to the processor identifying the at least one scene object in the scene image, the communication interface transmitting a control request to the at least one scene object to control the at least one scene object.

2. The interactive apparatus of claim 1, further comprising:
a storage, electrically connected to the processor;
wherein the interactive apparatus is further configured to execute the following operations:
the processor obtaining at least one identification data corresponding to the at least one scene object;
the communication interface receiving at least one certificate corresponding to the at least one scene object from a server, wherein the at least one certificate is generated by the server in response to receiving the at least one identification data from the interactive apparatus; and
the storage storing the at least one certificate;
wherein the control request transmitted by the communication interface further comprises the at least one certificate corresponding to the at least one scene object.

3. The interactive apparatus of claim 2, further comprising:
an input interface, configured to receive a command from the user;
wherein the interactive apparatus is further configured to execute the following operations:
in response to not identifying the at least one scene object in the scene image, the processor generating a menu based on the at least one certificate, wherein the menu comprises the at least one scene object corresponding to the at least one certificate;
the processor selecting one of the at least one scene object based on an input command received by the input interface; and
the communication interface transmitting the control request to the one of the at least one scene object.

4. The interactive apparatus of claim 1, wherein the operation of the processor determining whether the user is in the gaze status further comprises:
the processor calculating a plurality of pupil sizes and a plurality of sight angles based on a plurality of eye images in the face image; and
the processor determining whether the user is in the gaze status based on the pupil sizes and the sight angles.

5. The interactive apparatus of claim 1, wherein the recognition model further comprises a feature extraction layer and a classification layer, the feature extraction layer is configured to output a plurality of feature vectors based on the scene image, and the classification layer is configured to identify the at least one scene object in the scene image based on the feature vectors outputted by the feature extraction layer.

6. The interactive apparatus of claim 1, wherein the recognition model further comprises a feature extraction layer, and the interactive apparatus is further configured to execute the following operation:
the processor training the feature extraction layer based on at least one object image corresponding to the at least one scene object in the scene image.

7. The interactive apparatus of claim 1, wherein the recognition model further comprises a feature extraction layer, and the interactive apparatus is further configured to execute the following operations:
the communication interface receiving at least one preset image corresponding to the at least one scene object from a server; and
the processor training the feature extraction layer based on the at least one preset image.

8. The interactive apparatus of claim 1, wherein the interactive apparatus is further configured to execute the following operations:
the communication interface receiving an update parameter from a server; and
the processor updating the recognition model based on the update parameter.

9. The interactive apparatus of claim 1, wherein the at least one scene object comprises a first scene object and a second scene object, and the operation of the communication interface transmitting the control request to the at least one scene object further comprises:
the processor calculating a left-eye sight and a right-eye sight based on the face image;
based on an intersection of the left-eye sight and the right-eye sight, the processor calculating a projection point of the intersection on a plane;
the processor selecting a selected scene object from the first scene object and the second scene object based on the projection point; and
the communication interface transmitting the control request to the selected scene object to control the selected scene object.

10. The interactive apparatus of claim 9, wherein the communication interface further comprises a first antenna and a second antenna, and the operation of the processor selecting the selected scene object further comprises:
the first antenna and the second antenna receiving a plurality of positioning signals from the first scene object and the second scene object respectively;
the processor calculating a first projection point and a second projection point of the first scene object and the second scene object on the plane respectively based on the positioning signals; and
the processor selecting the selected scene object based on the projection point, the first projection point, and the second projection point.

11. An interactive apparatus control method, being adapted for use in an electronic apparatus, wherein the interactive apparatus control method comprises the following steps:
the electronic apparatus capturing a face image of a user and a scene image in a scene;
the electronic apparatus determining whether the user is in a gaze status based on the face image;
in response to the user being in the gazing status, the electronic apparatus identifying at least one scene object in the scene image by using a recognition model; and
in response to identifying the at least one scene object in the scene image, the electronic apparatus transmitting a control request to the at least one scene object to control the at least one scene object.

12. The interactive apparatus control method of claim 11, further comprising:
the electronic apparatus obtaining at least one identification data corresponding to the at least one scene object;
the electronic apparatus receiving at least one certificate corresponding to the at least one scene object from a server, wherein the at least one certificate is generated by the server in response to receiving the at least one identification data from the electronic apparatus; and
the electronic apparatus storing the at least one certificate;
wherein the control request transmitted by the electronic apparatus further comprises the at least one certificate corresponding to the at least one scene object.

13. The interactive apparatus control method of claim 12, further comprising:
in response to not identifying the at least one scene object in the scene image, the electronic apparatus generating a menu based on the at least one certificate, wherein the menu comprises the at least one scene object corresponding to the at least one certificate;
the electronic apparatus selecting one of the at least one scene object based on an input command received; and
the electronic apparatus transmitting the control request to the one of the at least one scene object.

14. The interactive apparatus control method of claim 11, wherein the step of the electronic apparatus determining whether the user is in the gaze status further comprises:
the electronic apparatus calculating a plurality of pupil sizes and a plurality of sight angles based on a plurality of eye images in the face image; and
the electronic apparatus determining whether the user is in the gaze status based on the pupil sizes and the sight angles.

15. The interactive apparatus control method of claim 11, wherein the recognition model further comprises a feature extraction layer and a classification layer, the feature extraction layer is configured to output a plurality of feature vectors based on the scene image, and the classification layer is configured to identify the at least one scene object in the scene image based on the feature vectors outputted by the feature extraction layer.

16. The interactive apparatus control method of claim 11, wherein the recognition model further comprises a feature extraction layer, and the interactive apparatus control method further comprises:
the electronic apparatus training the feature extraction layer based on at least one object image corresponding to the at least one scene object in the scene image.

17. The interactive apparatus control method of claim 11, wherein the recognition model further comprises a feature extraction layer, and the interactive apparatus control method further comprises:
the electronic apparatus receiving at least one preset image corresponding to the at least one scene object from a server; and
the electronic apparatus training the feature extraction layer based on the at least one preset image.

18. The interactive apparatus control method of claim 11, further comprising:
the electronic apparatus receiving an update parameter from a server; and
the electronic apparatus updating the recognition model based on the update parameter.

19. The interactive apparatus control method of claim 11, wherein the at least one scene object comprises a first scene object and a second scene object, and the step of the electronic apparatus transmitting the control request to the at least one scene object further comprises:
the electronic apparatus calculating a left-eye sight and a right-eye sight based on the face image;
based on an intersection of the left-eye sight and the right-eye sight, the electronic apparatus calculating a projection point of the intersection on a plane;
the electronic apparatus selecting a selected scene object from the first scene object and the second scene object based on the projection point; and
the electronic apparatus transmitting the control request to the selected scene object to control the selected scene object.

20. The interactive apparatus control method of claim 19, wherein the electronic apparatus further comprises a first antenna and a second antenna, and the step of the electronic apparatus selecting the selected scene object further comprises:
the first antenna and the second antenna receiving a plurality of positioning signals from the first scene object and the second scene object respectively;
the electronic apparatus calculating a first projection point and a second projection point of the first scene object and the second scene object on the plane respectively based on the positioning signals; and
the electronic apparatus selecting the selected scene object based on the projection point, the first projection point, and the second projection point.
